(19) United States
(12) Patent Application Publication
(10) Pub. No.: US 2026/0359096 A1
(43) Pub. Date: Nov. 12, 2026

(54) STREAMING ASYNCHRONOUS EXECUTION OF BLOCKCHAIN TRANSACTIONS

(71) Applicant: Ava Labs, Inc., New York, NY (US)

(72) Inventors: Arran Schlosberg, Bristol (GB); Stephen John Buttolph, Brooklyn, NY (US)

(21) Appl. No.: 19/670,402

(22) Filed: May 7, 2026

Related U.S. Application Data
(60) Provisional application No. 63/803,126, filed on May 9, 2025.

(51) Int. Cl. G06F 9/46; H04L 9/00

(52) U.S. Cl. CPC G06F 9/466; H04L 9/50

(57) ABSTRACT

Disclosed are techniques for performing asynchronous execution of blockchain transactions by a node of a blockchain network. A set of ordered, unexecuted transactions from a generated blockchain block are appended to a transaction queue. An execution worker processes each transaction sequentially by removing it from the queue, executing it, generating a receipt, and adding the receipt to current chunk data. During execution, a check is performed of whether the current chunk's remaining gas limit is sufficient. If the remaining gas limit is insufficient or the transaction queue is depleted, the current state of the blockchain network is determined, a state value is added to the current chunk data, and the chunk data is forwarded to a consensus worker for settlement in a subsequent blockchain block.

### CROSS-REFERENCE TO RELATED APPLICATIONS

This application claims the priority benefit of U.S. Provisional Patent Application No. 63/803,126, filed May 9, 2025, the entire contents of which are incorporated herein by reference.

### TECHNICAL FIELD

This document generally describes technology related to performing streaming asynchronous execution of blockchain transactions, by nodes of a blockchain network.

### BACKGROUND

In general, according to conventional interleaved blockchain transaction execution, a block time is partitioned into an initial execution portion and a subsequent consensus portion that occurs after a block's transactions have been executed. Data that corresponds to the execution of the block's transactions is included in the same block as the transactions themselves, and the block is added to the blockchain through a consensus protocol. Since consensus between validator nodes is latency sensitive, a time budget for the initial execution portion may be relatively small in comparison to the subsequent consensus portion. This synchronous approach can introduce inefficiencies due to execution delays and potential bottlenecks, especially under heavy transaction load.

### SUMMARY

This document generally describes technology for performing streaming asynchronous execution (SAE) of blockchain transactions, by nodes of a blockchain network. The presently described technology is designed to enhance scalability in decentralized blockchain networks. Transaction processing is separated into three distinct stages: acceptance, execution, and settlement. This separation enables blockchain nodes to perform consensus and execution in parallel while maintaining a globally consistent and deterministic view of blockchain state.

Transactions are first accepted into a blockchain network through a consensus protocol that orders them and adds them to a globally consistent first-in, first-out (FIFO) transaction queue. Notably, transactions are not executed at the time of acceptance. Instead, they are scheduled for future execution in the order determined through the consensus protocol. Eventual execution and on-chain settlement of the transactions is guaranteed, without immediate computation.

Execution proceeds independently from consensus, handled by dedicated execution workers that process transactions from the FIFO transaction queue during fixed-duration time intervals referred to as chunks. Each chunk has a predetermined gas limit, and transactions are executed sequentially until the chunk's gas capacity is exhausted, or until the queue is exhausted. Execution of the transactions produces transaction receipts and a state root, which together represent the result of transaction processing for that time interval. These results are stored locally and are later settled on the blockchain during a subsequent block, after a fixed delay.

The expected progress of the execution thread during any fixed-duration interval is unknown at the time of consensus and is, instead, reported by the execution thread at deterministic checkpoints. The consensus protocol can therefore enqueue any number of transactions, of any aggregate gas limit, regardless of the predicted time taken to execute all such transactions. This negates the need for conservative estimates of execution progress, which typically results in unused execution capacity. The variable delay between acceptance and execution decouples the two processes while ensuring deterministic state progression across nodes.

To prevent denial-of-service (DoS) attacks and ensure that the queue remains bounded under high load, the technology includes an adaptive gas pricing mechanism. A dynamic gas price is computed based on a function of accumulated excess gas consumption. When gas consumption exceeds a defined target, the accumulator increases, raising the minimum gas price for new transactions. When consumption is below the target, the accumulator decreases, reducing the gas price. This feedback mechanism regulates admission to the transaction queue and maintains network stability under bursty or adversarial workloads.

The technology also includes a deterministic chunk allocation model based on transaction completion time. If a transaction spans a boundary between two chunks due to insufficient gas capacity (computational cost that can serve as a proxy measure of processing time), a donation mechanism is triggered. Through the donation mechanism, the previous chunk is concluded early and residual gas is donated forward to a future chunk to ensure the transaction completes without violating timing guarantees for each chunk. Each transaction is attributed to the chunk during which its execution completes, thus preserving the determinism of recorded state and receipt data.

The technology also includes a worst-case validity check to determine whether an incoming transaction can be safely added to the transaction queue. This check assumes that the transaction will consume its full gas limit at the highest possible gas price, based on preceding transactions, which may be computed as a monotonic function of accumulated gas consumption. If the transaction sender has sufficient funds to cover this maximum cost, the transaction is accepted, guaranteeing its future execution regardless of network load. However, if the transaction sender has insufficient funds to cover this maximum cost, the transaction may be rejected or delayed.

The technology also includes an optional back-pressure queue window, in which a maximum cap can be imposed on the transaction queue. The maximum cap can ensure that the gap between actual and worst-case gas prices remains bounded, and can prevent unbounded growth of the transaction queue if execution lags behind consensus.

Overall, the technology enables high-throughput transaction processing and ensures fairness, reliability, and state consistency across all honest nodes. Transaction execution is supported under variable workloads and is particularly well-suited to high-volume applications such as decentralized finance, tokenized asset transfers, and autonomous smart-contract operations. The combination of asynchronous execution, gas regulation, and chunk-based scheduling defines an efficient approach to blockchain transaction processing.

One or more embodiments described herein may include a method for performing asynchronous execution of blockchain transactions by a node of a blockchain network. The method includes receiving a set of ordered and unexecuted transactions from a generated block of a blockchain; adding the set of ordered and unexecuted transactions at the end of a first-in, first-out (FIFO) transaction queue; sequentially processing one or more unexecuted transactions of the FIFO transaction queue by an execution worker of the node, the sequential processing comprising, for each unexecuted transaction: removing the unexecuted transaction from the front of the FIFO transaction queue; executing the unexecuted transaction, thereby generating an executed transaction; and after executing the unexecuted transaction, (i) generating a receipt for the executed transaction, and (ii) adding the receipt for the executed transaction to current chunk data; while executing the unexecuted transaction, determining whether a current chunk's remaining gas limit is sufficient for completing execution of a given unexecuted transaction; and in response to determining that the current chunk's remaining gas limit is insufficient for completing execution of the given unexecuted transaction or that the transaction queue has been depleted, (i) determining a current state value that reflects a current state of the blockchain network before completing the given unexecuted transaction, (ii) adding the current state value to the current chunk data, (iii) providing the current chunk data to a consensus worker of the node for settlement in a subsequent generated block of the blockchain.

Other embodiments of this aspect may include corresponding computer systems, and may include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions.

These and other embodiments may include any, all, or none of the following features. The operations can include continuing to execute the given unexecuted transaction after providing the current chunk data to the consensus worker. After completing execution of the given transaction, a given receipt can be generated for the given transaction. The given receipt for the given transaction can be added to subsequent chunk data of a subsequent chunk. The FIFO transaction queue can be maintained consistently across a plurality of blockchain nodes, and each transaction can be deterministically scheduled for execution in an order agreed upon during a consensus process in which the consensus worker performs. The current chunk can be associated with a fixed time interval. The current chunk can be associated with a predefined gas limit. A gas price can be calculated for the unexecuted transaction using a pricing function of accumulated excess gas consumption relative to a target gas rate. A determination can be performed of whether the unexecuted transaction satisfies a worst-case validity condition based on the calculated gas price, and based on the predefined gas limit for the current chunk. The unexecuted transaction can be executed in response to determining that the given unexecuted transaction satisfies the worst-case validity condition based on the calculated gas price and a predefined gas limit. A maximum cap can be imposed on the transaction queue. The execution worker and the consensus worker of the node can process transactions asynchronously and in parallel.

The devices, system, and techniques described herein may provide one or more of the following advantages.

Improved resource utilization. The separation of transaction acceptance, execution, and settlement enables blockchain nodes to perform consensus and execution tasks in parallel, thus reducing idle time and increasing overall system efficiency.

Enhanced throughput and scalability. By decoupling transaction acceptance from block execution, the system can process transactions more rapidly and continuously, allowing for higher throughput across varying transaction loads.

Deterministic state progression. The use of a globally consistent FIFO queue, combined with deterministic execution rules and fixed delays for settlement of state value in a blockchain, ensures consistency of the blockchain state across all honest nodes.

Reduced transaction latency for light nodes. Light nodes that execute transactions without participating in consensus can provide faster transaction execution while preserving correctness, as the deterministic queue ordering guarantees valid execution outcomes.

Robust handling of bursty or adversarial transactions, and robust handling of system events. A combination of variable queuing-to-execution delays and fixed execution-to-settlement delays enables a blockchain network to absorb spikes in transaction volume without violating determinism or overloading consensus mechanisms. Similarly, stop-the-world events such as database compaction can be amortized over multiple blocks.

Continuous operation of execution workers. Execution workers can process transactions uninterrupted and independent of consensus workers, limited only by a fixed gas throughput rate, thus maximizing node efficiency.

Dynamic load regulation and security. An exponential, monotonic gas pricing function adjusts admission thresholds based on recent network load, thus providing inherent resistance to denial-of-service (DoS) attacks and preventing unbounded queue growth.

Accurate chunk attribution and boundary handling. A deterministic chunk allocation model ensures that each transaction is attributed to the chunk during which execution completes, while the gas donation mechanism enables seamless handling of chunk overflow without violating execution deadlines or wasting computation resources.

The disclosed technology provides a technical solution to a technical problem related to the scalability, responsiveness, and reliability of blockchain networks under high transaction volumes. Traditional blockchain architectures tightly couple consensus and execution processes, leading to bottlenecks and reduced throughput when transaction volume surges. To address the technical problem, the disclosed technology separates transaction acceptance, execution, and settlement into distinct stages, enabling parallelization of consensus and execution operations. Further, a deterministic transaction queue and a dynamic gas pricing mechanism based on accumulated excess gas consumption can regulate transaction admission during periods of network congestion. Additionally, a chunk-based execution model with gas donation can ensure deterministic and timely progression of blockchain state without wasting computation resources caused by periods of dormancy. Together, these features allow blockchain networks to maintain high transaction throughput, predictable state evolution, and resilience to adversarial workloads, thus improving blockchain network performance.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a conceptual diagram of an example blockchain network system including multiple blockchain nodes participating in consensus and executing blockchain transactions.

FIG. 2 is a conceptual diagram of example blockchain consensus and blockchain transaction execution stages.

FIG. 3 is a Sankey diagram that illustrates the queuing of blockchain transactions and the asynchronous execution of the queued blockchain transactions over time.

FIGS. 4A-4E depict an example process flow for asynchronously executing blockchain transactions by a blockchain node at a series of time intervals.

FIG. 5 is a conceptual diagram that illustrates an example of chunk allocation and gas donation.

FIG. 6 depicts a series of equations for updating gas price for a blockchain network that asynchronously executes blockchain transactions, thereby dynamically controlling network load and transaction throughput.

FIG. 7 is a flow diagram of an example technique for asynchronous execution of blockchain transactions.

FIG. 8 is a schematic diagram that shows an example of a computing system.

Like reference symbols in the various drawings indicate like elements.

### DETAILED DESCRIPTION

This document generally relates to technology for performing streaming asynchronous execution (SAE) of blockchain transactions to improve scalability, determinism, and responsiveness in decentralized blockchain networks. Transaction processing is separated into three distinct stages—acceptance, execution, and settlement—thus allowing consensus and execution to proceed independently while maintaining a globally consistent blockchain state.

Transactions are ordered and accepted through a blockchain network's consensus protocol, and are then added to a globally consistent FIFO transaction queue. The transactions are later executed by dedicated execution workers, within fixed-duration time intervals referred to herein as chunks. During each chunk, transactions are processed sequentially until a chunk's gas limit is reached (or until the queue is exhausted), producing transaction receipts and a new blockchain state (e.g., a state root). Transactions refer to unexecuted requests for actions, whereas transaction receipts refer to results of said actions being executed. Execution results are stored and settled on the blockchain after a fixed delay.

To manage network load and prevent denial-of-service (DoS) attacks, for example, the blockchain network adjusts the minimum gas price dynamically using a pricing function based on recent excess gas consumption. This regulates queue growth and ensures stability of the blockchain network. A chunk allocation scheme based on completion time ensures that transactions are recorded in the chunk where execution finishes. A donation mechanism enables transaction processing to carry forward when a chunk's gas limit is reached, thus preserving chunk execution deadlines without wasting computation resources. This architecture supports high-throughput applications while ensuring consistent state across the blockchain network.

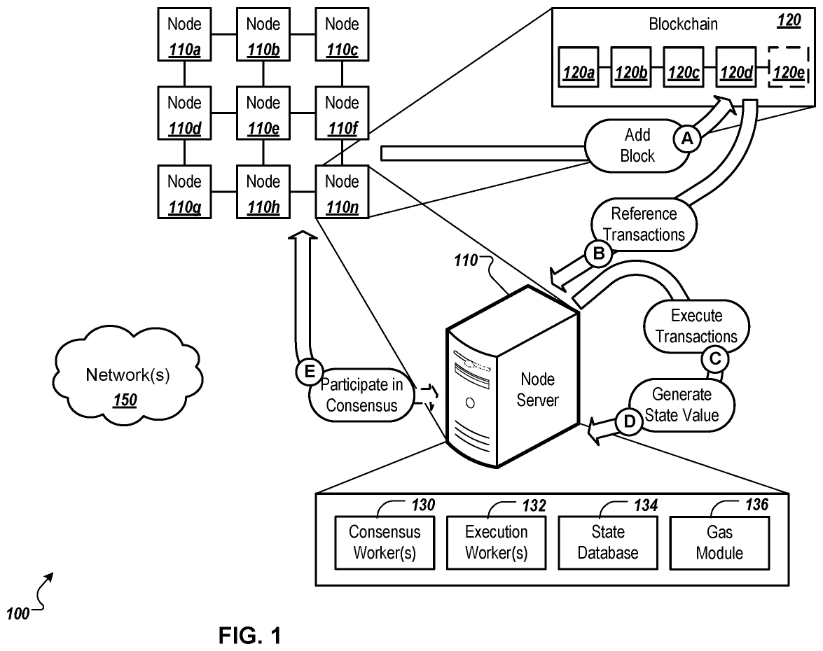

FIG. 1 is a conceptual diagram of an example blockchain network system 100 including multiple blockchain nodes participating in consensus and executing blockchain transactions. In the present example, the system 100 includes a plurality of blockchain nodes 110a-n, each blockchain node being configured to asynchronously execute blockchain transactions and to maintain a blockchain 120 in accordance with embodiments of the present document. The blockchain nodes 110a-n, for example, can include validator nodes, archive nodes, full nodes, light nodes, or other sorts of blockchain nodes that participate in a decentralized blockchain network. The blockchain nodes 110a through 110n can communicate over one or more networks 150 (e.g., including one or more LANs (local area networks), WANs (wide area networks), and/or the Internet) to propagate transactions and blocks and to synchronize blockchain state data.

Each of the blockchain nodes 110a-n of the blockchain network can represent various forms of servers, including but not limited to network servers, application servers, or other suitable computing servers. Each of the nodes 110a-n can include one or more processors, memory devices, and storage devices. In the present example, the nodes 110a-n are configured as a peer-to-peer network, in which nodes can be flexibly added to or removed from the blockchain network over time. Each of the nodes 110a-n in the peer-to-peer blockchain network, for example, can directly communicate with other network nodes, and can participate in network functions, such as executing code (e.g., blockchain application software, smart contracts, etc.), broadcasting and validating blockchain transactions, generating new blocks of transactions, verifying generated blocks, and so forth. Further, each of the nodes 110a-n can maintain a separate copy of the blockchain 120, to ensure decentralization, robustness, and persistence of the blockchain network.

The blockchain 120, for example, can include a series of consecutively added and linked blocks (e.g., blocks 120a-e), with each block including references for transactions that were included in the blockchain network over consecutive time windows of substantially similar durations (e.g., a fraction of a second, a second, or several seconds, depending on the type and configuration of the blockchain network). Each block in the blockchain 120 can be linked to a previous block through a cryptographic hash. For example, block 120b can include a cryptographic hash of block 120a, block 120c can include a cryptographic hash of block 120b, block 120d can include a cryptographic hash of block 120c, and so forth, such that the data in a given block cannot be altered once it is added to the blockchain 120, without altering subsequent blocks.

A node server 110 (e.g., a respective server of any of the blockchain nodes 110a-n) can perform various operations related to both consensus and execution of blockchain transactions. To perform such operations, for example, the node server 110 can execute one or more consensus worker(s) 130 and execution worker(s) 132, which may be implemented as software and/or hardware components (e.g., execution threads), and which may operate concurrently and independently from one another. The consensus worker(s) 130, for example, can be configured to participate in a consensus protocol to generate and validate blocks. The execution worker(s) 132, for example, can be configured to asynchronously process transactions referenced in the blocks. Further, the node server 110 can include additional components (including software and/or hardware components), such as a state database 134 and a gas module 136. The state database 134 (e.g., implemented as a Merkle Trie, or another suitable data structure) can maintain information that pertains to the current state of the blockchain 120, such as account balances, contract code, and data stored by smart contracts. As transactions are processed, for example, the node server 110 can update the state database 134 to reflect the new state of the blockchain 120, such that the state database 134 is continually updated as the blockchain 120 evolves over time. The gas module 136, for example, can dynamically adjust gas prices based on current network transaction load (e.g., using a monotonic pricing function). Operations of the node server 110 (e.g., including the operations of the one or more consensus worker(s) 130, the one or more execution worker(s) 132, the state database 134, and the gas module 136) are discussed in further detail elsewhere in this document.

As used herein, the term “gas” refers to a unit of computational cost associated with executing operations on a blockchain network. Each transaction submitted to the blockchain network can be associated with a gas-consumption limit, which reflects the maximum total computational resources needed to fully execute the transaction. During execution, gas may be consumed by various operations such as arithmetic computation, data storage and retrieval, smart contract logic execution, and blockchain state updates. The total gas consumption of a transaction is used by the blockchain network to account for transaction complexity and to enforce execution limits. In general, gas consumption can serve as a proxy for time, in that a computational cost for executing a transaction (e.g., a number of compute cycles) correlates to an amount of time for executing the transaction. Execution chunks (fixed-duration execution intervals) are subject to a per-chunk gas limit, which constrains the maximum amount of computation that may be performed during a given time interval (e.g., a real-world clock time window). The use of gas ensures consistent and bounded transaction processing, and supports dynamic pricing mechanisms to regulate transaction throughput across the network.

As further illustrated in FIG. 1, an example process flow is shown for performing asynchronous execution of blockchain transactions by the blockchain network system 100, as represented in example stages (A) to (E). Stages (A) to (E) may occur in the illustrated sequence, or they may occur in a sequence that is different than in the illustrated sequence, and/or two or more stages (A) to (E) may be concurrent. In some examples, one or more stages (A) to (E) may be repeated multiple times when performing asynchronous execution of blockchain transactions.

During stage (A), the blockchain network adds a newly generated block to a local chain of blocks after agreement via the consensus protocol. For example, each of the blockchain nodes 110a-n can add block 120d to a locally maintained instance of the blockchain 120. Block 120d, for example, can include an ordered set of transactions that have not yet been executed by the blockchain network. The transactions, for example, can include requests to transfer cryptocurrency (e.g., digital tokens) between blockchain accounts, requests to execute smart contracts, or other sorts of transaction requests submitted by various blockchain users (e.g., client devices). Upon receiving the transaction requests, for example, the nodes 110a-n can validate and order the transaction requests, and can generate the block (e.g., block 120d) that includes the transaction requests.

During stage (B), nodes of the blockchain network reference the ordered transactions from the newly added block and add the transactions to the end of a first-in, first-out (FIFO) transaction queue. For example, the node server 110 (which can represent a server of any of the blockchain nodes 110a-n) can reference the ordered set of unexecuted transactions included in block 120d, and can add the unexecuted transactions to a locally maintained queue data structure (e.g., maintained in local memory of the node server 110), behind previously requested transactions that also have yet to be executed. The FIFO transaction queue, for example, may be globally consistent across all honest nodes and may serve as the execution queue for the blockchain network.

During stage (C), nodes of the blockchain network begin processing transactions from the front of the FIFO transaction queue in a sequential manner. For example, the node server 110 can use the execution worker(s) 132 to sequentially remove and execute transactions included in the FIFO transaction queue. While executing the transactions, for example, the node server 110 can group transaction receipts that result from executed transactions into a batch of chunk data for a current execution chunk, with each execution chunk corresponding to a fixed wall-clock time interval and being subject to a predetermined gas limit (e.g., according to the gas module 136). As used herein, a chunk refers to a discrete execution time interval (e.g., a fraction of a second, a second, or several seconds) during which a blockchain node performs operations for processing one or more transactions from a transaction queue. Each chunk is subject to a predefined computational resource limit, such as a gas limit. As used herein, chunk data refers to a set of execution metadata for a chunk, including transaction receipts and state value(s). In general, the transaction receipts can contain data that identifies the executed transactions and that pertains to the outcomes of the transactions, such as gas used, logs, return data, status data, etc. In the present example, the node server 110 can continue executing transactions from the FIFO transaction queue until the chunk's gas capacity is exhausted or until the queue is temporarily depleted.

During stage (D), nodes of the blockchain network generate state values that reflect a current state of the blockchain 120 (e.g., based on data maintained in the state database 134) after executing transactions from the FIFO transaction queue. For example, the node server 110 can update the state database 134 to reflect the current state of the blockchain 120 after executing each transaction. As another example, the node server 110 can update the state database 134 to reflect the current state of the blockchain 120 after executing the transactions for a current chunk. A state value (which may also be referred to as state root, a cryptographic fingerprint of the blockchain state) can be associated with a corresponding execution chunk, and can be finalized for recording in a subsequent block of the blockchain 120 after a fixed time delay (e.g., a second, several seconds, etc.).

During stage (E), nodes of the blockchain network participate in a consensus protocol. For example, the node server 110 can use the consensus worker(s) 130 to submit the current chunk data (e.g., including transaction receipts for each of the transactions executed in one or more prior chunk(s), and a state value that reflects the state of the blockchain 120 after executing the transactions) for settlement in a subsequent block. In general, each new block of the blockchain 120 can record the finalized execution results from the one or more prior chunks, including the state root and transaction receipts. In some implementations, a block with timestamp t_{B} may record the results from the chunk executed at time t_{C}=t_{B}−d, where d is a predetermined delay interval measured in seconds. For example, during stage (E), the node server 110 can submit the chunk data for the transactions that had been executed during stage (C) (which were included across one or more previous blocks 120a-d), the transactions being intended for settlement in block 120e or a subsequent block.

The example process flow can continue thusly, with stages (A) (the addition of blocks) and (E) (participation in consensus) occurring concurrently and asynchronously with stages (B) (the referencing of transactions), (C) (the execution of transactions), and (D) (the generation of state values). Furthermore, stage (A) of one round of the process flow may correspond with stage (E) of one or more earlier rounds, by finalizing earlier transactions while simultaneously agreeing on a new batch to append to the transaction queue. The separation between transaction acceptance, execution, and settlement enables more efficient resource utilization, reduces idle time for execution operations, and improves overall transaction throughput.

In some implementations, a blockchain node may operate as a light node that does not directly participate in consensus, but that simply references unexecuted transactions, and executes at least some of the transactions. For example, the node server 110 can reference unexecuted transactions as the transactions are added to the blockchain 120 (e.g., at stage (B)), and can execute the transactions (e.g., at stage (C)), without generating a state value (e.g., at stage (D)), and without participating in the consensus protocol (e.g., at stage (E)). By focusing solely on executing the transactions, for example, the node server 110 can avoid the generation of a state value (e.g. a cryptographic fingerprint of the blockchain state), and can simply continue processing transactions as the transactions are added to the blockchain 120, as fast as the server is capable. Thus, in the present example, the node server 110 can determine an eventual state of the blockchain 120 based on all of the transactions submitted to the blockchain 120, before such transactions are fully processed by the validator nodes of the blockchain network. While the transactions have not yet been fully processed by the validator nodes, the transaction execution results generated by the node server 110 (a light node) can be presumed to be correct due to the deterministic nature of the transaction queue of the blockchain 120.

In general, the expedited generation of transaction results can serve to provide faster transaction times for light nodes. For example, when operating as a light node, the node server 110 can be configured to filter the transaction queue for particular externally owned accounts (EOAs), thereby immediately crediting account balances (e.g. as tracked by third-party systems). Further, EOA-to-EOA transfers of value may be considered settled immediately after being executed by the light node, without waiting for the rest of the blockchain network to process the transactions. As another example, the node server 110 (when operating as a light node) can locally clear the transaction queue in advance of the rest of the blockchain network, thereby facilitating faster decentralized finance (DeFi) capabilities.

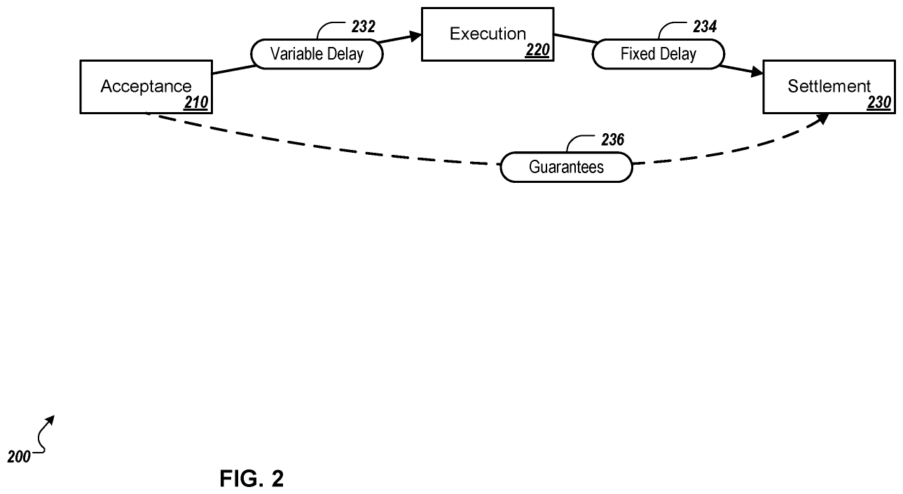

FIG. 2 is a conceptual diagram 200 of example blockchain consensus and blockchain transaction execution stages in an asynchronous execution framework, in accordance with embodiments of the present document. As noted above in connection with FIG. 1, blockchain transaction processing under the present framework separates the transaction lifecycle into three stages: acceptance, execution, and settlement. These stages, respectively, represent the time at which a transaction is approved by consensus for inclusion in a block of the blockchain and enqueued for future execution, the time at which the transaction is actually executed by an execution worker of a node, and the time at which the results of that execution are incorporated into a subsequent block of the blockchain.

During an acceptance stage 210, for example, a transaction is added to a block by a proposer node (e.g., one of the nodes 110a-n) and is subsequently approved through the consensus protocol of the blockchain network. Notably, acceptance of a transaction does not imply that the transaction has been executed. Rather, the acceptance stage 210 represents consensus agreement on an ordering of the transaction and inclusion of the transaction in a FIFO transaction queue maintained across nodes of the blockchain network. Following acceptance, the transaction is deterministically scheduled for future execution, and its eventual settlement on the blockchain is guaranteed (though the exact execution time is not known at the moment of acceptance).

Following acceptance, during an execution stage 220, for example, transactions are processed sequentially from the FIFO queue by execution workers (e.g., the execution worker(s) 132, shown in FIG. 1) operating independently from the consensus protocol. Execution occurs within a defined execution interval or chunk. Each chunk has an associated gas limit, and a chunk may be filled when the FIFO transaction queue has been exhausted, or the chunk's remaining gas capacity is insufficient for processing the next transaction. The execution stage 220 is asynchronous with respect to consensus, and may occur at any time after the transaction is accepted into the queue. Because the execution order is strictly determined by the ordering of the queue, and because each node operates over an identical queue with deterministic transaction behavior, the blockchain state resulting from execution is consistent across all honest nodes.

Following execution, the transaction enters a settlement stage 230. The settlement stage 230, for example, represents the point at which the outcome of a previously executed transaction is recorded on-chain by a subsequent block. This settlement may occur with a fixed delay, such that a block at time t_{B} records the state root and transaction receipts produced by the execution chunk at time t_{C}=t_{B}−d, where d is a predefined delay interval in seconds. The fixed delay generally refers to a system-defined constant (e.g., 1 second, 2 seconds, 3, seconds, or another suitable amount of time) that determines how long after execution the chunk data is recorded on-chain. The settlement of execution results occurs irrespective of the block in which the transaction was originally accepted. For example, a transaction accepted at time t_{A} may be executed at time t_{C} and settled in a block at time t_{B}=t_{C}+d. This delayed settlement model ensures determinism while maintaining execution and consensus as independent, parallel processes.

The diagram 200 also depicts a variable delay 232 associated with the time between acceptance 210 and execution 220, and a fixed delay 234 associated with the time between execution 220 and settlement 230. As used herein, a variable delay generally refers to an amount of time that a transaction remains in-queue before execution. The variable delay 232, for example, reflects that transactions may remain in the FIFO transaction queue for an undetermined period before being executed, depending on network load. The fixed delay 234, in contrast, ensures that settlement of state roots and transaction receipts in the blockchain occurs at predictable intervals after transactions are executed. The combination of variable delay 232 and fixed delay 234 allows an execution pipeline to flexibly absorb bursty transaction volume without compromising determinism or state consistency in a blockchain network.

Finally, the diagram 200 includes a set of guarantees 236 associated with each stage of the transaction lifecycle. At the acceptance stage 210, for example, the blockchain network system 100 guarantees that a transaction is validly formed, has passed minimum gas cost checks (e.g., via a worst-case gas cost analysis), and will eventually be executed. At the execution stage 220, for example, the system 100 guarantees that the transaction is processed in order relative to other transactions, with deterministic outcomes (e.g. via a FIFO queue or any other mechanism that respects consensus ordering and the results in an equivalent final state, such as but not limited to optimistic concurrency control). At the settlement stage 230, for example, the system 100 guarantees that the transaction's result is made final and is publicly recorded on-chain. Further, through these stage-specific guarantees, the delayed settlement model can guarantee that a transaction that is accepted at the acceptance stage 210 will eventually be executed at the executed stage 220, and will then eventually be finalized at the settlement stage 230.

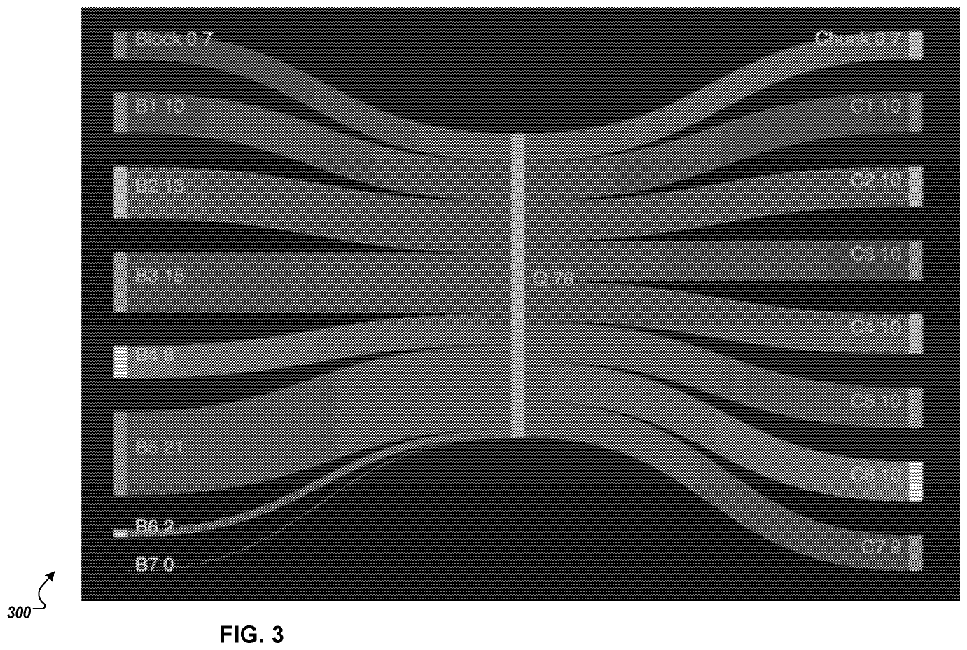

FIG. 3 is a Sankey diagram 300 that illustrates the queuing of blockchain transactions and the asynchronous execution of the queued blockchain transactions over time. In the illustrated example, time proceeds from the top to the bottom of the diagram 300, with blocks being generated at fixed intervals (e.g., one block per second). Each newly generated block includes a set of transactions that are accepted by the blockchain consensus protocol and added to a first-in, first-out (FIFO) transaction queue. The Sankey diagram 300 illustrates the flow of accepted transactions from the consensus stream into an execution stream, and provides a visual representation of how transaction data accumulates and is processed over time by a blockchain network that supports streaming asynchronous execution.

As shown in FIG. 3, a series of blocks (e.g., blocks 0 through 7) are arranged along the left-hand side of the diagram 300, each representing a point in the consensus timeline at which new blocks are generated by the blockchain network, and at which transactions from those blocks are added to the transaction queue. For example, each block may include one or more transactions submitted by users (e.g., clients), such as value transfers, smart contract calls, or other sorts of transactions, in which the exact computational cost of each transaction is deterministic but not yet known. During consensus and block generation, the blockchain network does not attempt to estimate or pre-evaluate the gas cost or execution time of each transaction. Instead, the blockchain network simply agrees upon the transaction content and the transaction order. The transactions are then added to the FIFO transaction queue, in the agreed-upon order. This is conceptually represented by the horizontal flows in the Sankey diagram 300, where bands of variable thickness are introduced from each block into a vertical FIFO transaction queue (e.g., labeled as “Q” at the center of the diagram 300).

The FIFO transaction queue may conceptually be viewed as a conveyor belt of pending transactions to be executed according to the queued order. From each new block, additional transactions are appended to the end of this queue, preserving their relative ordering. In this model, consensus workers (e.g., the consensus worker(s) 132, shown in FIG. 1) of blockchain nodes are solely responsible for determining the sequence and content of accepted transactions. Execution, by contrast, is handled independently by execution workers (e.g., the execution worker(s) 132, also shown in FIG. 1) of the blockchain nodes along a parallel timeline. These workers consume transactions from the queue according to resource availability and predefined system constraints.

Execution proceeds along the right-hand side of the diagram 300, from top to bottom, and occurs within fixed-duration processing intervals known as chunks (e.g., chunks 0 through 7). Each chunk corresponds to a time window (e.g., a one second time window, or another suitable time window) during which an execution worker is allowed to process up to a fixed amount of compute (e.g., measured in gas units). The maximum amount of compute per chunk may be defined by a system-wide execution rate (shown as 10 gas units per second in the present example). Each chunk processes as many transactions from the queue as it can, ending when either the chunk's gas capacity is exhausted, or the queue is depleted at the corresponding block time. The execution stream is shown in the rightward flow of transaction bands from the FIFO transaction queue to successive chunks.

The thickness of each transaction band shown in the diagram 300 represents the compute weight (e.g., gas cost) of the transactions processed in each chunk. Because gas costs are not known at the time of consensus, the consensus streams on the left-hand side simply contribute transactions to the FIFO transaction queue, whereas the execution streams on the right-hand side reveal how much compute the transactions actually use as the transactions are executed. Although each band on the left-hand side of the diagram has an explicit thickness, this is only to depict the deterministic gas requirement that will eventually be revealed during execution. This distinction is central to the architecture of streaming asynchronous execution, in which the decoupling of consensus from execution allows the system 100 to dynamically accommodate transactions of varying complexity and avoid overcommitment of computation resources during consensus. Further, this two-stream model (with consensus producing the transaction queue and execution consuming from it) allows the system 100 to decouple block frequency from execution frequency with respect to transaction processing. Transactions are not executed strictly within the block in which they were accepted, nor are transactions executed at a predetermined block after the block in which they were accepted. Instead, transactions are executed in the order they appear in the queue, and their results are recorded in undetermined future blocks according to a fixed delay after execution.

By visualizing the transaction execution pipeline in this manner, the diagram 300 clarifies the flow of transactions from consensus acceptance to asynchronous execution. The diagram 300 also highlights how the system 100 allows transaction deadlines to be defined in terms of gas consumption that corresponds to elapsed time, rather than block number. This improves responsiveness, allows for better handling of unpredictable transaction workloads, and avoids the inefficiencies associated with asynchronous but block-bound execution. Execution workers can operate continuously, and the blockchain network can scale more efficiently as transaction volume grows.

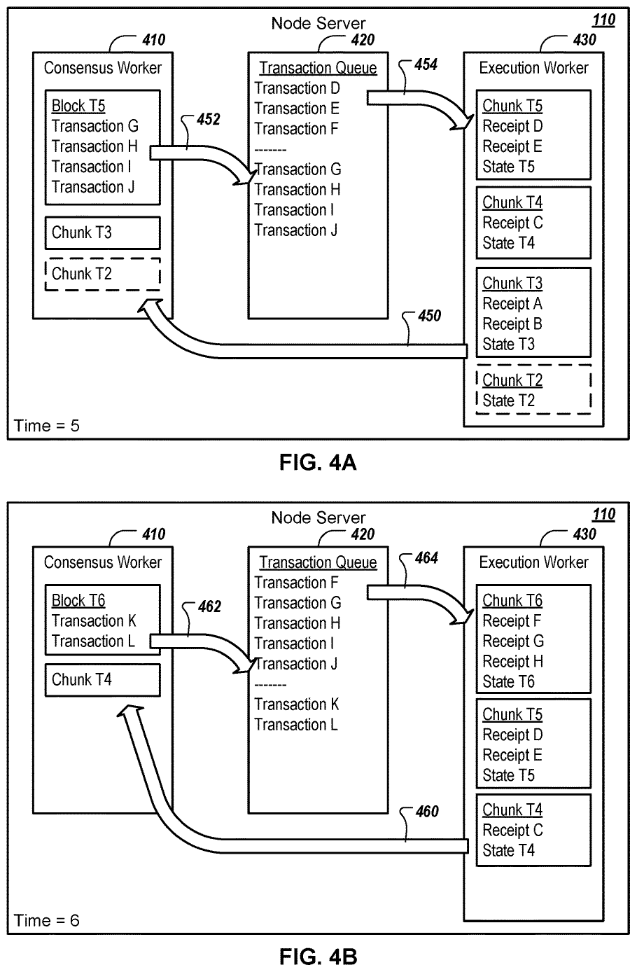

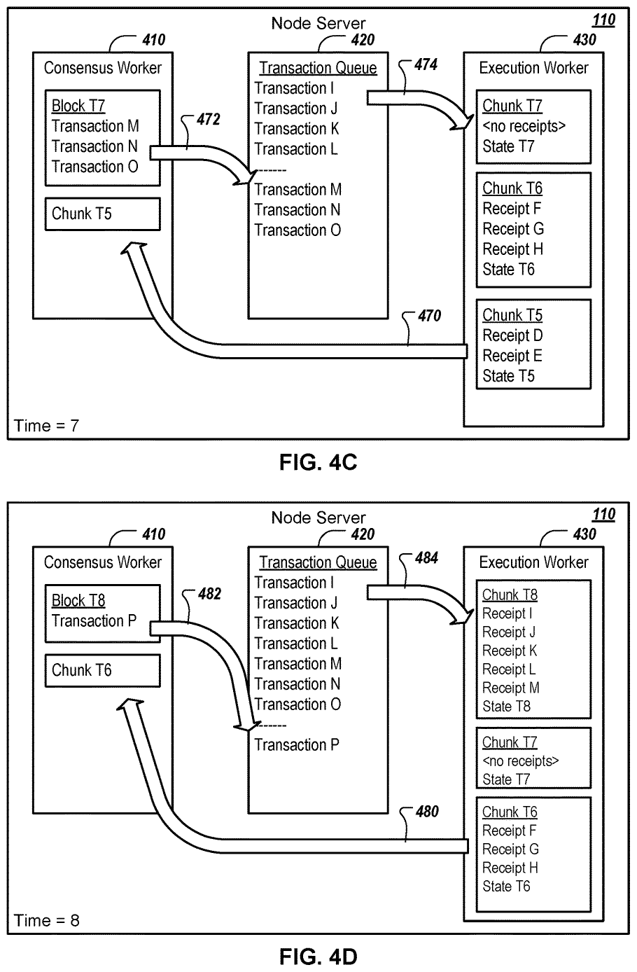

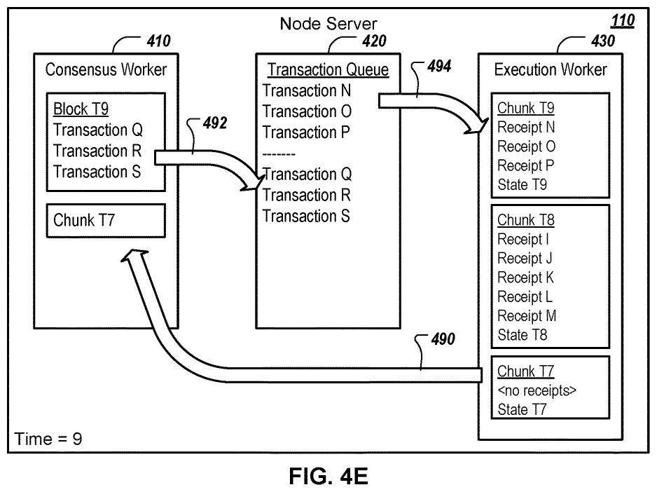

FIGS. 4A-4E depict an example process flow for asynchronously executing blockchain transactions by a blockchain node at a series of time intervals. The example process flow can be coordinated by the node server 110 (also shown in FIG. 1), which includes a consensus worker 410 (e.g., similar to the consensus worker(s) 130, shown in FIG. 1), an execution worker 430 (e.g., similar to the execution worker(s) 132, shown in FIG. 1), and a transaction queue 420 (e.g., a FIFO transaction queue). Further, the node server 110 can maintain various sets of chunk data representing previously processed and currently processing transactions. In the present example, the process flow of FIGS. 4A-4E is depicted at a series of time intervals T5 through T9. Each time interval, for example, can represent the passing of one second (or another suitable time interval), and can be based on a system clock that coordinates a block time for adding blocks to the blockchain 120 with a chunk time for filling chunks. Although depicted as being added on regular intervals, blocks can be added on an ad-hoc basis with arbitrary non-negative inter-block periods. As another possibility, rather than aligning chunks with fixed time intervals, chunks may be aligned with blocks (while setting the chunks based on time).

Referring to FIG. 4A, the node server 110 is shown at a particular time interval (e.g., time=5). In the present example, during time interval T5, and as shown by arrow 450, the consensus worker 410 can receive chunk data that corresponds to previous time interval (e.g., chunk T3), which precedes the current time interval (e.g., T5) by a fixed amount of time (e.g., two seconds, or another suitable time delay). The chunk data for chunk T3, for example, can include a state of the blockchain 120 at the time of completion of the chunk (e.g., state T3), and can include transaction receipts for blockchain transactions that had finished executing during the chunk and zero or more previous chunks (e.g., including receipts A and B for the execution of respective transactions A and B) that have not yet been settled by the consensus worker 410. Upon receiving the chunk data for chunk T3 (and zero or more previous chunks), for example, the consensus worker 410 can settle the chunk data in a current block (e.g., block T5), and can add the current block T5 to the blockchain 120 through a consensus protocol. While the present example shows chunk data for a single chunk (e.g., chunk T3) being settled in a current block (e.g., block T5), it is to be understood that one or more prior chunks (e.g., chunk T2) can also be settled in the current block, possibly clearing the entire transaction queue 420. Such a scenario may occur, for example, when a consensus process is delayed (e.g., due to a communication lag or other sort of system failure) or when there is temporarily no network demand.

As shown in the present example, the current block T5 (e.g., a newly generated block) includes a set of new, unexecuted transactions, including transactions G, H, I, and J. These transactions have been ordered through the consensus protocol, and as shown by arrow 452, are appended to the end of the FIFO transaction queue 420, preserving their determined sequence. The transaction queue 430, in the present example, also includes transactions D, E, and F, which were previously added in earlier blocks but have not yet been executed as of time interval T5.

Concurrently and independently, the execution worker 430 operates over the same FIFO transaction queue 420. During time interval T5, and as shown by arrow 454, the execution worker 430 processes transactions at the front of the queue, removing transactions D and E and executing them in sequence. Each executed transaction generates a corresponding transaction receipt (e.g., receipt D and receipt E), which each may include data such as gas used, logs, return values, and other execution metadata. Further, a state value (e.g., a cryptographic hash of the updated blockchain state) that reflects the state of the blockchain 120 after executing those transactions (e.g., state T5) can be accessed from the state database 134 (shown in FIG. 1). The generated receipts (e.g., receipts D and E), and the current state value (e.g., state T5) are collected into current chunk data labeled as chunk T5. In the present example, chunk T5 may be deemed full upon reaching a predefined gas capacity or when execution time for the current time interval T5 elapses as measured by some other deterministic proxy of network time. The finalized state value (e.g., state T5) associated with chunk T5 is recorded internally by the node server 110 but will not yet be added to the blockchain 120 until a future block, consistent with the fixed-delay model described in connection with FIG. 2.

Referring now to FIG. 4B, the node server 110 is shown at a subsequent time interval (e.g., time=6). In the present example, during time interval T6, and as shown by arrow 460, the consensus worker 410 can receive chunk data that corresponds to a previously completed time interval (e.g., chunk T4), which precedes the current time interval T6 by a fixed amount of time (e.g., two seconds). The chunk data for chunk T4 can include a state of the blockchain 120 at the time of completion of chunk T4 (e.g., state T4), along with transaction receipts for blockchain transactions that had completed execution during that chunk (e.g., receipt C for transaction C). Upon receiving the chunk data for chunk T4, the consensus worker 410 can settle the chunk data in a current block (e.g., block T6), and can finalize block T6 for inclusion in the blockchain 120 using a consensus protocol.

As shown in the present example, the current block T6 (e.g., a newly generated block) includes a set of newly accepted, unexecuted transactions (e.g., transactions K and L), which are ordered by the consensus worker 410 and added to the FIFO transaction queue 420, as shown by arrow 462. These transactions are appended to the end of the queue 420, behind previously added transactions that remain unexecuted, including transactions F, G, H, I, and J. As a result, the queue 420 now reflects a queue ordering from F through L, maintaining the sequencing that enables deterministic execution across all nodes.

During time interval T6, and as shown by arrow 464, the execution worker 430 concurrently and independently processes transactions from the front of the queue 420. In the present example, the execution worker 430 removes and executes transactions F, G, and H. Each executed transaction generates a corresponding transaction receipt (e.g., receipts F, G, and H), which are added to a current chunk labeled as chunk T6. The execution worker 430 further determines a state value (e.g., state T6) that reflects the updated blockchain state after executing the above transactions. The state T6 value may be computed based on the new state of the blockchain 120, as maintained in the state database 134 (shown in FIG. 1), and represents a fingerprint of the post-execution state at the conclusion of time interval T6. The chunk data for chunk T6, including receipts F, G, H, and I, and state T6, can be retained by the node server 110 until it is scheduled for settlement in a future block according to a fixed delay offset (e.g., two seconds). This delay allows execution operations to remain decoupled from consensus operations while preserving deterministic state evolution across the blockchain network.

As shown in the present example, earlier chunks (e.g., chunk T4 and chunk T5) are maintained for reference by current and/or future settlement processes. Chunk T5, generated during the previous time interval (T5), includes receipts D and E and the corresponding state T5. Chunk T4, now aged by two time intervals, includes receipt C and state T4 and is shown as being transmitted to the consensus worker 410 as part of a settlement process in the current time interval T6. These chunks collectively illustrate the sequential evolution of the blockchain state and support the delayed settlement model described in FIG. 2.

Referring now to FIG. 4C, the node server 110 is shown at a subsequent time interval (e.g., time=7). In the present example, during time interval T7, and as shown by arrow 470, the consensus worker 410 can receive chunk data corresponding to a previously completed time interval (e.g., chunk T5), which precedes the current time interval T7 by a fixed amount of time (e.g., two seconds). The chunk data for chunk T5 can include a state of the blockchain 120 at the time of completion of chunk T5 (e.g., state T5), and can include transaction receipts for blockchain transactions that were executed during chunk T5 (e.g., receipts D and E). Upon receiving the chunk data for chunk T5, the consensus worker 410 can settle the chunk data in a current block (e.g., block T7) and finalize block T7 for inclusion in the blockchain 120 through a consensus protocol.

As shown in the present example, the current block T7 (e.g., a newly generated block) includes a set of new, unexecuted transactions (e.g., transactions M, N, and O). These transactions have been ordered through the consensus protocol, and as shown by arrow 472, are appended to the end of the FIFO transaction queue 420, preserving their determined sequence. The transaction queue 420 at time T7 already includes unexecuted transactions I, J, K, and L, carried over from previous time intervals. With the addition of transactions M, N, and O, the queue 420 is updated to reflect a new ordered transaction sequence from I through O.

As shown in the present example, the execution worker 430 is also operating during time interval T7. However, the execution worker 430 does not complete any new transactions during this interval. Instead, and as shown by arrow 474, a new chunk (e.g., labeled as chunk T7) is initiated, but no receipts are recorded. For example, the gas cost for processing transaction I may be such that it exceeds the gas limit for chunk T7. At the conclusion of time interval T7, for example, the chunk T7 can be associated with a state value (e.g., state T7) that represents the state of the blockchain 120 at the conclusion of this time interval, even though no new receipts are to be settled. Since no transactions completed execution during the current time interval (e.g., time interval T7), for example, the state value for the current chunk (e.g., state T7 for chunk T7) can be the same as the state value for the previous chunk (e.g., state T6 for chunk T6).

As shown in the present example, chunks from earlier intervals (e.g., chunk T5 and chunk T6) are maintained for reference by current and/or future settlement processes. Chunk T6 includes receipts F through H and state T6. Chunk T5 includes receipts D and E and state T5, which is being incorporated into the blockchain 120 through the consensus process. Chunk T7, which is currently in progress, reflects the transition point between executed and unexecuted transactions. The presence of a chunk without any receipts indicates that either a large transaction (e.g., transaction I) is in the process of being executed or that system-level parameters (e.g., gas exhaustion, compute throttling) have limited execution within the time window.

The present example further illustrates the flexibility of the streaming asynchronous execution framework of the system 100, which supports dynamic transaction scheduling while preserving deterministic ordering and consistent state progression. Even in time intervals where no transactions are fully completed, the system 100 continues to generate state values and prepare execution chunks for future settlement, enabling the node server 110 to maintain continuous, parallel consensus and execution pipelines.

Referring now to FIG. 4D, the node server 110 is shown at a subsequent time interval (e.g., time=8). In the present example, during time interval T8, and as shown by arrow 480, the consensus worker 410 can receive chunk data corresponding to a previously completed time interval (e.g., chunk T6), which precedes the current time interval T8 by a fixed delay (e.g., two seconds). The chunk data for chunk T6 can include a state of the blockchain 120 at the time of completion of chunk T6 (e.g., state T6), as well as transaction receipts for blockchain transactions that completed execution during chunk T6 (e.g., receipts F, G, and H). Upon receiving the chunk data for chunk T6, the consensus worker 410 can settle the chunk data in a current block (e.g., block T8), and can finalize block T8 for inclusion in the blockchain 120 through a consensus protocol.

As shown in the present example, block T8 (e.g., a newly generated block) includes a single new unexecuted transaction (e.g., transaction P). As shown by arrow 482, the transaction is appended to the end of the FIFO transaction queue 420. The transaction queue 420 already includes unexecuted transactions I through O, carried over from prior time intervals. After appending transaction P, the queue is updated to reflect a new ordered sequence from I through P.

During time interval T8, the execution worker 430 continues processing from the front of the transaction queue 420. As shown by arrow 484, the execution of transaction I is completed during this interval, and a corresponding receipt (e.g., receipt I) is generated. Further, the execution of transactions J, K, L, and M are also completed during time interval T8, and corresponding receipts J, K, L, and M are generated for each of the transactions. The generated transaction receipts are added to a new execution chunk labeled as chunk T8. The execution worker 430 also updates the blockchain state based on the effect of the executed transactions and records a new state value (e.g., state T8), reflecting the state of the blockchain 120 at the end of the current time interval T8. The state value can be accessed from the state database 134 (as described in FIG. 1), and can represent a deterministic snapshot of blockchain state after executing the transactions.

In the present example, chunk T8 (now containing receipts I, J, K, L, and M, and state T8), is retained internally by the node server 110. Data that corresponds to chunk T8 is scheduled for settlement in a subsequent block (e.g., block T10), based on the fixed delay offset configured in the system 100. As in prior examples, this delay decouples the execution of transactions from their settlement on-chain, allowing the execution worker 430 to operate independently from the block proposal and consensus activities of the consensus worker 410.

As shown in the present example, previously generated chunks T6 and T7 are maintained for reference by current and/or future settlement processes. Chunk T6 includes receipts F, G, and H, and state T6, and is being processed for settlement in block T8 by the consensus worker 410. Chunk T7, generated during the previous time interval T7, contains no transaction receipts and carries forward state T6 (e.g., state T7 =state T6) due to the lack of any fully executed transactions in that interval. Chunk T8, now in progress, reflects resumed execution activity and successful progression of the execution pipeline.

The present example shown in FIG. 4D reinforces the determinism and resilience of the asynchronous execution framework of the system 100. Even when conspicuous progression through the FIFO transaction queue 420 had been temporarily stalled (as shown in FIG. 4C), the system 100 ensures continuity by maintaining valid state checkpoints and transaction ordering. When progression through the queue 420 continues, for example, progress is captured in new chunks without disrupting the consensus or transaction flow. This model enables the node server 110 to support continuous operation and predictable execution pacing, even under uneven load conditions.

Referring now to FIG. 4E, the node server 110 is shown at a subsequent time interval (e.g., time=9). In the present example, during time interval T9, and as shown by arrow 490, the consensus worker 410 can receive chunk data corresponding to a previously completed time interval (e.g., chunk T7), which precedes the current time interval T9 by a fixed delay (e.g., two seconds). The chunk data for chunk T7, for example, can include a state of the blockchain 120 at the time of completion of chunk T7 (e.g., state T7), which may be equivalent to the previous state (e.g., state T6), and can include an empty receipt set (e.g., no executed transactions). Upon receiving the chunk data for chunk T7, for example, the consensus worker 410 can settle the chunk data in a current block (e.g., block T9) and can finalize block T9 for inclusion in the blockchain 120 using a consensus protocol.

In the present example, the current block T9 (e.g., a newly generated block) includes a set of newly accepted, unexecuted transactions (e.g., transactions Q, R, and S). These transactions are ordered through the consensus protocol and, as shown by arrow 492, are appended to the end of the FIFO transaction queue 420. The transaction queue 420 already includes unexecuted transactions N, O, and P, carried over from previous time intervals. With the addition of transactions Q, R, and S, the transaction queue 420 is updated to reflect a new ordered sequence from N through S.

During time interval T9, the execution worker 430 continues processing transactions from the front of the queue 420. As shown by arrow 494, the execution of transactions N, O, and P is completed during this interval, and corresponding transaction receipts (e.g., receipts N, O, and P) are generated. These receipts are collected into a new chunk labeled as chunk T9. In addition, the execution worker 430 generates a new state value (e.g., state T9), representing the updated state of the blockchain 120 after completing the execution of transactions N, O, and P. The new state value can be accessed from the state database 134 and reflects a deterministic post-execution snapshot for the current time interval T9.

In the present example, chunk T9 (e.g., containing receipts N, O, and P and state T9), is retained internally by the node server 110 and scheduled for settlement in a future block (e.g., block T11), consistent with the fixed-delay offset configured in the system 100. The delay continues to decouple the timing of transaction execution from the timing of settlement in the blockchain, allowing for continuous execution progress without disruption to consensus operations.

As shown in the present example, prior chunks are retained for reference or settlement. Chunk T7, which includes no receipts and state T7, is received and incorporated into block T9 through the consensus process. Chunk T8, generated during time interval T8, contains receipts I through M and state T8, and is retained for future settlement. Chunk T9, now in progress, reflects active execution of transactions and continued advancement through the transaction queue 420.

The present example of a multi-interval process flow for asynchronously executing blockchain transactions in accordance with the streaming asynchronous execution framework of the system 100 is concluded. As shown throughout FIGS. 4A through 4E, the system 100 enables deterministic transaction ordering, parallelized execution and consensus workflows, and consistent blockchain state progression. The fixed-delay model ensures orderly state finalization, while the FIFO queue structure guarantees transaction determinism across all nodes, even in periods of fluctuating transaction complexity and/or volume.

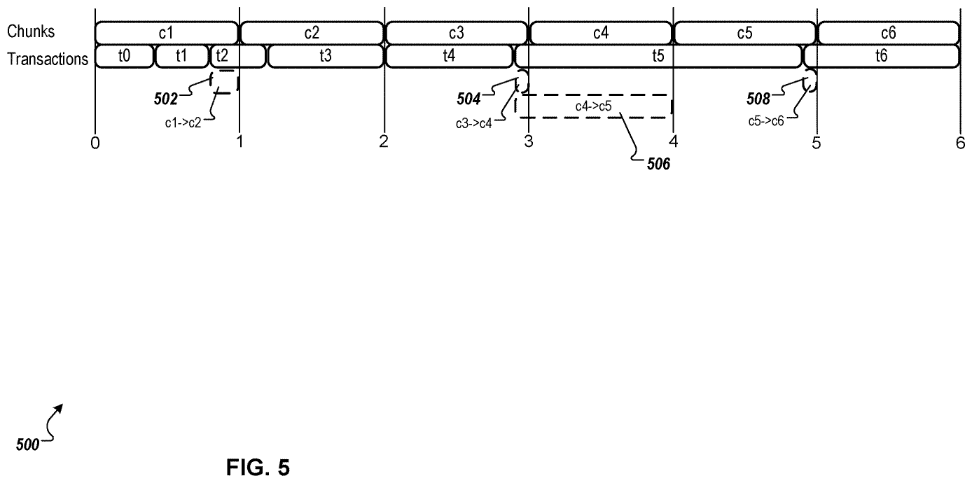

FIG. 5 is a conceptual diagram 500 that illustrates an example of chunk allocation and gas donation in the blockchain network system 100 implementing streaming asynchronous execution. The present example highlights how transactions are deterministically assigned to execution chunks based on completion time, and how gas donation is used to preserve chunk-based execution deadlines while maximizing computational efficiency across time intervals. As used herein, gas donation refers to a mechanism by which unconsumed gas capacity from one execution chunk is logically transferred to a subsequent chunk in a streaming asynchronous execution environment. Gas donation occurs when a transaction that begins execution during a given chunk cannot complete within that chunk's gas limit or time budget as measured by some other deterministic proxy of network time. In such cases, the unconsumed residual capacity is donated forward, allowing the next chunk to use the excess compute budget without violating defined chunk boundaries, deadline constraints, or gas consumption rates. The donation ensures that execution deadlines are met and that computing resources maintain continuous processing across chunk intervals. Transaction receipts are attributed to the chunk in which execution completes, not the chunk in which execution began.

In the present example, a sequence of transactions (e.g., transactions t0 through t6) is processed from a transaction queue (e.g., the FIFO transaction queue 420, shown in FIGS. 4A-4E). Each transaction is associated with an actual gas cost, and for purposes of this example, it is assumed that the transaction load exceeds the available capacity of the blockchain network, such that the transaction queue is not exhausted. Each execution chunk in the present example (e.g., chunks c1 through c6) corresponds to a fixed time window and a fixed compute budget (e.g., a gas limit defined by a gas rate that corresponds to a maximum amount of gas that may be consumed per unit of time by a blockchain node during transaction execution). Further, each chunk in the present example is indexed to denote the time interval at which the chunk completes.

The processing of transaction t0 through t6 in the present example can be performed by one or more execution workers (e.g., the execution worker 430, shown in FIGS. 4A-4E). Once the execution worker(s) have begun processing a transaction, for example, the worker(s) can continue processing the transaction to completion. At completion of the transaction processing, for example, the worker(s) can generate chunk data (e.g., including receipts that result from executed transactions) for including in an execution chunk that corresponds to a time period in which the time of execution at completion occurs (e.g., through a chuck filling process, which refers to a deterministic process of assigning transactions to chunks based on their execution completion time, gas consumption, and chunk capacity constraints).

In general, the criteria for chunk filling in this context define a deterministic allocation strategy in which each transaction is assigned to the chunk during which its execution completes. That is, no chunk is permitted to end earlier than the completion time of its last assigned transaction. This model ensures that each chunk's state root is an accurate and timely record of completed work, that transaction receipts are not prematurely recorded, and that all nodes 110 compute the same inter-chunk boundaries. Chunks may vary in the number of transactions they reference, depending on the relative gas cost of those transactions and the available capacity of the chunk.

As shown in diagram 500, transactions t0 and t1 together consume less gas than the gas limit for a single execution chunk, and are therefore assigned to chunk c1. However, the addition of transaction t2 would exceed the capacity of chunk c1, and so it is allocated to the next chunk, chunk c2. This transition marks a donation event 502, in which the residual compute capacity from chunk c1 is donated forward to chunk c2. The donation enables chunk c2 to absorb both transaction t2 data and the subsequent transaction t3 data, which completes execution within the chunk's adjusted capacity.

Continuing the present example of diagram 500, chunk c3 receives only transaction t4 data, which is the only transaction that fits within its capacity. The next transaction, t5, exceeds the gas capacity of a single chunk. As a result, transaction t5 begins execution during chunk c4, but does not complete during that time interval. This triggers a donation event 504, in which the unconsumed gas from chunk c3 is donated to chunk c4. However, even with this donation, chunk c4 cannot accommodate the full transaction, and chunk c4 produces no new receipts. The state root for chunk c4 may therefore be identical to that of chunk c3, and chunk c4 is categorized as an empty interim chunk (a chunk in which no transactions complete execution and which may reuse the previous state value).

Continuing the present example, the unconsumed donation from chunk c3 continues forward, through chunk c4, to chunk c5. This transitive forwarding results in donation event 506, in which the compute capacity that was originally available in chunk c3 is ultimately applied to chunk c5. Transaction t5 completes execution during chunk c5, and the corresponding transaction receipt for transaction t5 and the updated state root of the blockchain 120 are recorded in chunk c5. Chunk c5 thereby references work that was initiated in a time interval associated with a prior chunk, but that completed during a subsequent time interval.

Continuing the present example, the final transaction in the sequence, t6, begins execution during a time interval that corresponds to chunk c5, but is unable to finish during the time interval. This results in donation event 508, where the unfilled capacity from chunk c5 is effectively rolled forward to chunk c6. Execution of the transaction t6 eventually finishes during a subsequent time interval that corresponds to chunk c6, and the resulting state root of the blockchain 120 and receipt of transaction t6 are recorded in chunk c6, consistent with the deterministic execution completion allocation technique described herein.

The donation mechanism illustrated by donation events 502, 504, 506, and 508 ensures that all chunks meet their respective deadlines, while optimizing use of processing resources of nodes of the blockchain network. Each chunk's state root reflects the state of the blockchain 120 as of the last completed transaction prior to its ending boundary, and each transaction receipt is recorded in a chunk during which the transaction actually finishes. Further, the donation mechanism ensures saturation of blockchain node compute resources. That is, execution workers continue processing transactions even if their results are not available for recording before an ending time boundary of a current chunk. Finally, the donation mechanism supports sustained, high-throughput operation under varying transaction loads, while preserving deterministic execution and consensus behavior across the blockchain network.

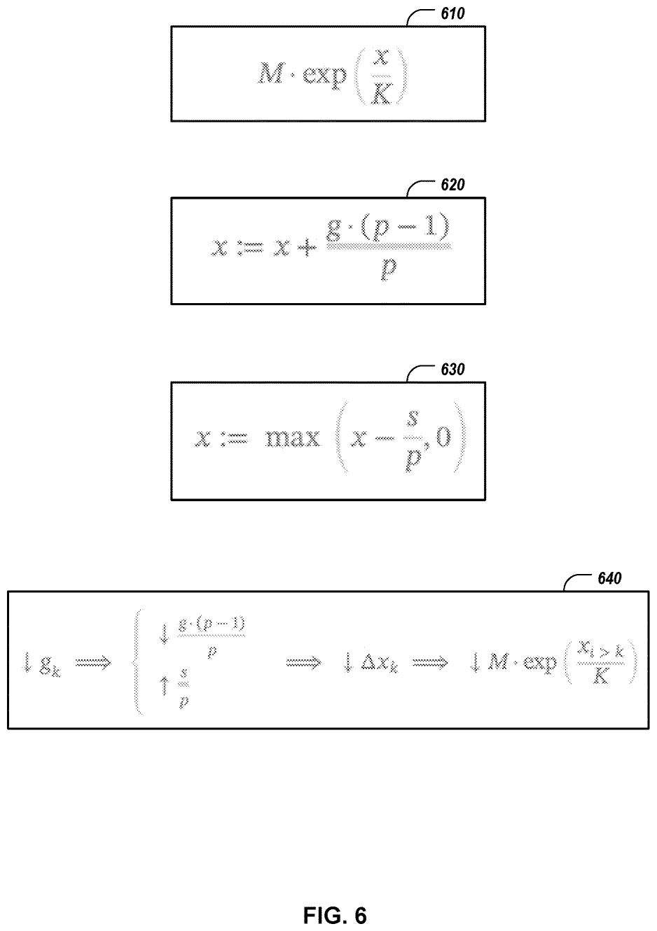

FIG. 6 depicts a series of equations 610, 620, 630, and 640 for updating gas price for a blockchain network that asynchronously executes blockchain transactions, thereby dynamically controlling network load and transaction throughput. The equations 610, 620, 630, and 640, for example, can be executed by the gas module 136 of the node server 110 (shown in FIG. 1), according to an exponential pricing model configured to enforce security and load regulation in a streaming asynchronous execution architecture. The system 100, for example, can use a dynamic pricing mechanism to adjust the minimum gas price for newly accepted transactions based on recent levels of network demand. The dynamic pricing mechanism can ensure that transaction admission remains bounded under adversarial or bursty workloads, and that the system is protected from denial-of-service (DoS) attacks. This ensures that a transaction queue (e.g., the FIFO transaction queue 420 described in FIGS. 4A-4E) remains bounded, even under conditions of high network load.

In the context of the equations 610, 620, 630, and 640, gas refers to a computational accounting unit that quantifies the cost of executing a blockchain transaction. Each transaction is associated with a gas limit, indicating the maximum computational effort the transaction is permitted to consume, and a gas price, indicating how much a transaction sender is willing to pay per unit of gas. The total fee for a transaction is determined as the product of gas used and gas price.

In general, gas pricing can be governed by a continuously updated variable x, referred to as the accumulated excess gas consumption, which serves as a pressure accumulator for recent transaction load relative to a target rate. When the system 100 consumes more gas than the target rate over time, x increases, raising the gas price for future transactions. When the system consumes less than the target, x decays, lowering the gas price for future transactions.

The parameters used by the equations 610, 620, 630, and 640 shown in FIG. 6 are summarized as follows:
T: target gas consumed per second (e.g., the nominal network throughput),
M: minimum gas price (baseline),
K: gas price update constant (price sensitivity),
R: gas capacity added per second (e.g. the network capacity).

The gas price at any given moment can be determined by an exponential pricing function, shown in equation 610, which defines a minimum gas price M, with x being the accumulated excess gas consumption, and with K being a gas price update constant controlling price sensitivity. This function increases monotonically with x, creating a natural disincentive for transaction spam or congestion.

The system 100 can maintain the variable x through discrete updates applied at regular intervals (e.g., per block, per chunk, per transaction, etc.). For example, after executing a given transaction, the execution worker 430 (shown in FIGS. 4A-4E) can update the variable x that is applied for future transactions. During each update, if the gas consumed during that interval exceeds the target gas rate T, x is incremented. If the gas consumed is less than the target, x decays. The update is captured by a pressure accumulation function, shown in equation 620, with g being the actual gas used in the interval, p being a targeting parameter that can, for example, be derived from R and T (e.g., 2, or another suitable value), and with an increase to x reflecting increased pressure due to above-target consumption. When gas consumption is below the target, x is reduced by a decay step through a pressure decay function, as shown in equation 630, with s being a gas surplus, p being the targeting parameter (e.g., 2, or another suitable value), and with a decrease to x reflecting decreased pressure due to the transaction queue being drained. With a targeting parameter p=2, for example, half of all gas consumed is added to excess while half of all surplus is deducted, although other values for p are possible based on a desired operation of the blockchain network. Taken together, equations 620 and 630 define a bounded feedback loop for tracking load pressure, and equation 610 defines the resulting price, although any set of feedback equations that balance system load can be used.

To illustrate the impact of this particular instance of a feedback mechanism, example equation 640 summarizes the causal relationship between gas consumption, pricing pressure, and dynamic price adjustment. Specifically, a decrease in gas consumed during interval k reduces accumulated excess gas consumption xₖ, leading to a corresponding decrease in the minimum gas price for future transactions. Conversely, higher-than-target gas consumption leads to an increase in xₖ, raising the gas price for future transactions. This monotonic behavior ensures that the gas price responds in the same direction as changing network load.

In general, the function described by example equation 640 plays a role in securing a transaction queue against overload conditions. Prior to adding an incoming transaction to the transaction queue (e.g., during the acceptance stage 210, shown in FIG. 2), a blockchain node server (e.g., node server 110, shown in FIG. 1) performs a worst-case validity check for the transaction. The worst-case validity check assumes that the incoming transaction and all preceding transactions in the queue will consume their entire gas limits. This results in an upper bound of the potential gas price to be paid for the transaction, since gas price is modeled as a monotonic function of accumulated gas consumption. The combination of the maximum price and the maximum consumption results in the maximum possible cost. The blockchain node server then verifies whether the entity that submitted the transaction has sufficient funds (e.g., an amount of cryptocurrency) to cover the worst-case gas cost, thus ensuring that the transaction will be executable regardless of future load. Transactions that are associated with sufficient funds, for example, can be added to the transaction queue, whereas transactions that are not associated with sufficient funds can be rejected or delayed until sufficient funds become available. This ensures that accepted transactions are viable under the highest possible load, and that insufficiently funded transactions are excluded. As a result, transaction acceptance under worst-case validity is a guarantee of transaction settlement (as described with respect to FIG. 2).

Furthermore, this mechanism serves as a built-in queue Denial of Service (DoS) protection system. By ensuring that each transaction commits to a maximum gas limit and is validated against a dynamically increasing price floor, the system 100 can prevent adversaries from flooding a transaction queue with low-cost transactions that could otherwise clog execution resources. Because the accumulated excess gas consumption x is updated continuously in response to actual usage, and because the minimum gas price rises in response to sustained excess load, admission of new transactions becomes progressively more restrictive as pressure increases, thereby throttling demand in proportion to network congestion.

In some implementations, a back-pressure queue window can be used to impose a maximum cap on a transaction queue. For example, a blockchain node server (e.g., node server 110, shown in FIG. 1) can impose a maximum cap (e.g., a number of transactions or a total gas limit) on the transaction queue 420 (e.g., shown in FIGS. 4A-4E), which acts as a proxy for determining that the execution worker 430 is taking longer to process transactions than the consensus worker 410. Thus, in the present example, operations of the consensus worker 410 are effectively slowed down such that the transaction queue 420 does not increase unboundedly. By capping the transaction queue 420, for example, the impact of a worst-case validity check can also be reduced with respect to unfavorable DoS conditions. Further, the difference between a worst case gas price and an action gas price can be well bounded.

The deterministic nature of this gas pricing logic complements the overall asynchronous execution framework of the system 100. Just as execution workers are deterministically assigned transactions via the transaction queue (e.g., as shown in FIGS. 4A-4E), the minimum gas price applied at the moment of transaction acceptance is likewise deterministically computed based on x. In this way, pricing dynamics remain synchronized across honest nodes and serve as a mechanism for sustaining high-throughput transaction processing without compromising fairness or security.

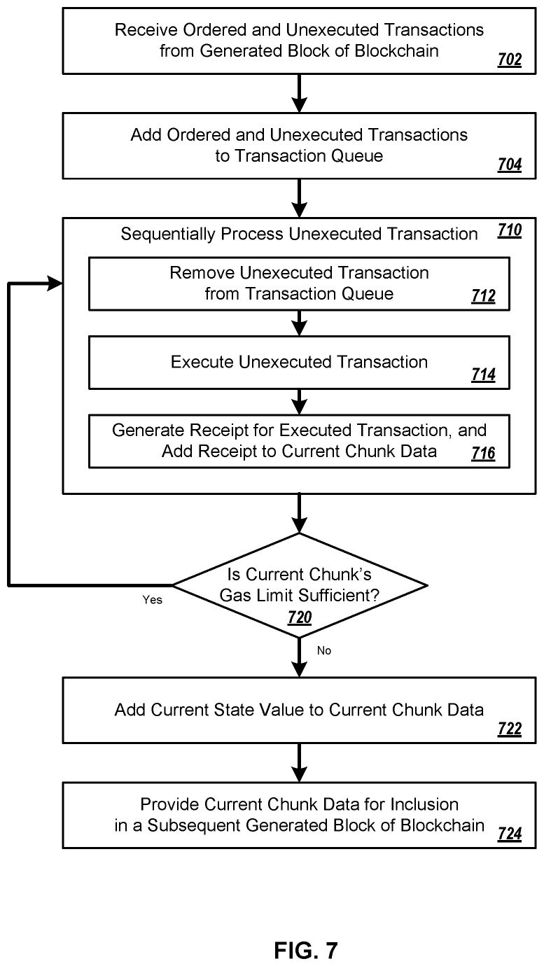

FIG. 7 is a flow diagram of an example technique 700 for asynchronous execution of blockchain transactions, in accordance with embodiments of the present document. The example technique 700 can be performed by a node of a blockchain network (e.g., the node server 110 shown in FIG. 1), and will be described as such for clarity. In particular, the example technique 700 includes operations related to the receipt, queuing, chunk-based execution, and eventual settlement of blockchain transactions in a manner consistent with the streaming asynchronous execution framework described throughout this document.

At block 702, the node server 110 receives a set of ordered and unexecuted transactions from a generated block of a blockchain. This operation corresponds to the initial transaction acceptance phase shown in FIG. 2 (e.g., acceptance) and is further illustrated in FIG. 4A-4E, in which transactions are received via consensus and appended to a FIFO transaction queue. The ordering of the transactions is determined through the consensus protocol, ensuring consistency across nodes.

At block 704, the node server 110 adds the set of ordered and unexecuted transactions to the end of the FIFO transaction queue. The queue may be implemented as shown in FIGS. 4A-4E (e.g., queue 420), for example, which preserves the deterministic ordering of transactions across blockchain nodes. Alternatively, the queue may be implemented via other suitable order-aware mechanisms that result in an equivalent post-execution state to that produced by a FIFO queue.

At block 710, one or more execution workers of the node server 110 sequentially process transactions from the FIFO transaction queue. This operation corresponds to the transaction execution phase shown in FIG. 2 (e.g., execution 220), and is further illustrated in FIGS. 4A-4E, in which transactions are executed by the execution worker 430. The sequential processing operations include removing a transaction from the front of the queue (block 712), executing the transaction (block 714), and after execution, generating a receipt and adding the receipt to the current chunk data (block 716). These operations correspond to the transaction processing and chunk formation operations shown in FIGS. 4A-4E.

At block 720, during execution, the node server 110 determines whether the current chunk's remaining gas limit is sufficient for completing execution of the transaction. This reflects the gas-bound execution limits described in FIGS. 4A-4E, FIG. 5, and FIG. 6, in which a transaction receipt for a currently executing transaction may be relegated to a subsequent chunk if insufficient gas remains in the current execution chunk.

If the remaining gas for the current chunk is sufficient, for example, operations continue at block 710, where the node server 110 processes a next transaction from the FIFO transaction queue. The node server 110 can continue processing transactions from the queue until the queue is exhausted, or until a gas limit for the current chunk is reached.

If the remaining gas is insufficient, for example, operations continue at block 722, where the node server 110 determines the current state value of the blockchain before completing the transaction. The state value (e.g., a state root or cryptographic fingerprint) represents the blockchain state up to the last successfully executed transaction and may be accessed from a state database (e.g., state database 134, as shown in FIG. 1). The node server 110 adds the determined state value and the current chunk data to a structure suitable for on-chain settlement. This corresponds to the chunk data submission process shown in FIGS. 4A-4E, where transaction receipts and state values are packaged for eventual settlement in a subsequent block.

At block 724, the current chunk data is provided to a consensus worker of the node for settlement in a future block of the blockchain. This operation corresponds to the settlement phase of FIG. 2 (e.g., settlement 230), and is further illustrated in FIGS. 4A-4E, in which chunk data is provided to the consensus worker 410. This operation reinforces the fixed-delay model, in which execution chunk results are incorporated into a block that follows the execution interval by a predefined time offset (e.g., a second, two seconds, three seconds, or another suitable time offset).

The operations shown in FIG. 7 collectively ensure that transaction acceptance, execution, and settlement proceed deterministically, even when transactions span multiple chunks (as discussed in the context of FIG. 5). Additional operations for continued execution of a deferred transaction and the use of donation mechanisms may be performed as described elsewhere in this document.

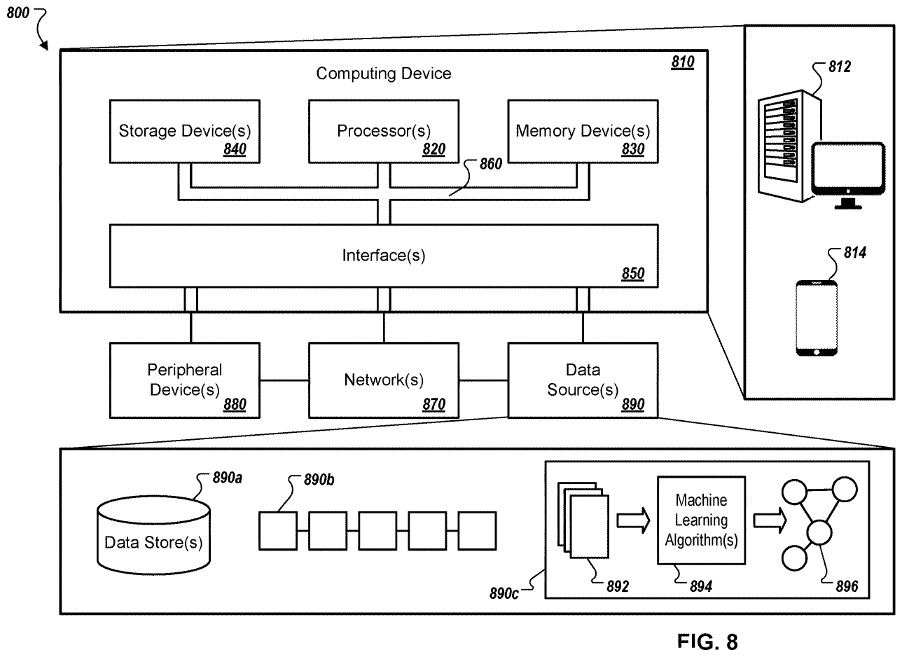

FIG. 8 is a schematic diagram that shows an example of a computing system 800 that may be used to implement the techniques described herein. The computing system 800 includes one or more computing devices (e.g., computing device 810), which may be in wired and/or wireless communication with various peripheral device(s) 880, data source(s) 890, and/or other computing devices (e.g., over network(s) 870). The computing device 810 may represent various forms of stationary computers 812 (e.g., workstations, kiosks, servers, mainframes, edge computing devices, quantum computers, etc.) and mobile computers 814 (e.g., laptops, tablets, mobile phones, personal digital assistants, wearable devices, etc.). In some implementations, the computing device 810 may be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) may include components of the computing device 810, and an entire system may be made up of multiple devices communicating with each other. For example, the computing device 810 may be part of a computing system that includes a network of computing devices, such as a cloud-based computing system, a computing system in an internal network, or a computing system in another sort of shared network. Processors of the computing device 810 and other computing devices of a computing system may be optimized for different types of operations, secure computing tasks, etc. The components shown herein, and their functions, are meant to be examples, and are not meant to limit implementations of the technology described and/or claimed in this document.

The computing device 810 includes processor(s) 820, memory device(s) 830, storage device(s) 840, and interface(s) 850. Each of the processor(s) 820, the memory device(s) 830, the storage device(s) 840, and the interface(s) 850 are interconnected using a system bus 860. The processor(s) 820 are capable of processing instructions for execution within the computing device 810, and may include one or more single-threaded and/or multi-threaded processors. The processor(s) 820 are capable of processing instructions stored in the memory device(s) 830 and/or on the storage device(s) 840. The memory device(s) 830 may store data within the computing device 810, and may include one or more computer-readable media, volatile memory units, and/or non-volatile memory units. The storage device(s) 840 may provide mass storage for the computing device 810, may include various computer-readable media (e.g., a floppy disk device, a hard disk device, a tape device, an optical disk device, a flash memory or other similar solid state memory device, or an array of devices, including devices in a storage area network or other configurations), and may provide date security/encryption capabilities.

The interface(s) 850 may include various communications interfaces (e.g., USB, Near-Field Communication (NFC), Bluetooth, WiFi, Ethernet, wireless Ethernet, etc.) that may be coupled to the network(s) 870, peripheral device(s) 880, and/or data source(s) 890 (e.g., through a communications port, a network adapter, etc.). Communication may be provided under various modes or protocols for wired and/or wireless communication. Such communication may occur, for example, through a transceiver using a radio-frequency. As another example, communication may occur using light (e.g., laser, infrared, etc.) to transmit data. As another example, short-range communication may occur, such as using Bluetooth, WiFi, or other such transceiver. In addition, a GPS (Global Positioning System) receiver module may provide location-related wireless data, which may be used as appropriate by device applications. The interface(s) 850 may include a control interface that receives commands from an input device (e.g., operated by a user) and converts the commands for submission to the processors 820. The interface(s) 850 may include a display interface that includes circuitry for driving a display to present visual information to a user. The interface(s) 850 may include an audio codec which may receive sound signals (e.g., spoken information from a user) and convert it to usable digital data. The audio codec may likewise generate audible sound, such as through an audio speaker. Such sound may include real-time voice communications, recorded sound (e.g., voice messages, music files, etc.), and/or sound generated by device applications.

The network(s) 870 may include one or more wired and/or wireless communications networks, including various public and/or private networks. Examples of communication networks include a LAN (local area network), a WAN (wide area network), and/or the Internet. The communication networks may include a group of nodes (e.g., computing devices) that are configured to exchange data (e.g., analog messages, digital messages, etc.), through telecommunications links. The telecommunications links may use various techniques (e.g., circuit switching, message switching, packet switching, etc.) to send the data and other signals from an originating node to a destination node. In some implementations, the computing device 810 may communicate with the peripheral device(s) 880, the data source(s) 890, and/or other computing devices over the network(s) 870. In some implementations, the computing device 810 may directly communicate with the peripheral device(s) 880, the data source(s), and/or other computing devices.

The peripheral device(s) 880 may provide input/output operations for the computing device 810. Input devices (e.g., keyboards, pointing devices, touchscreens, microphones, cameras, scanners, sensors, etc.) may provide input to the computing device 810 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) may provide output from the computing device 810 (e.g., user-directed output and/or other output that results in actions being performed in a physical environment). Other kinds of devices may be used to provide for interactions between users and devices. For example, input from a user may be received in any form, including visual, auditory, or tactile input, and feedback provided to the user may be any form of sensory feedback (e.g., visual feedback, auditory feedback, or tactile feedback).

The data source(s) 890 may provide data for use by the computing device 810, and/or may maintain data that has been generated by the computing device 810 and/or other devices (e.g., data collected from sensor devices, data aggregated from various different data repositories, etc.). In some implementations, one or more data sources may be hosted by the computing device 810 (e.g., using the storage device(s) 840). In some implementations, one or more data sources may be hosted by a different computing device. Data may be provided by the data source(s) 890 in response to a request for data from the computing device 810 and/or may be provided without such a request. For example, a pull technology may be used in which the provision of data is driven by device requests, and/or a push technology may be used in which the provision of data occurs as the data becomes available (e.g., real-time data streaming and/or notifications). Various sorts of data sources may be used to implement the techniques described herein, alone or in combination.

In some implementations, a data source may include one or more data store(s) 890a (e.g., databases, or other sorts of data management systems). The data store(s) may be provided by a single computing device or network (e.g., on a file system of a server device) or provided by multiple distributed computing devices or networks (e.g., hosted by a computer cluster, hosted in cloud storage, etc.). In some implementations, a database management system (DBMS) may be included to provide access to data contained in database(s) (e.g., through the use of a query language and/or application programming interfaces (APIs)). The database(s), for example, may include relational databases, object databases, structured document databases, unstructured document databases, graph databases, and other appropriate types of databases.

In some implementations, a data source may include one or more blockchains 890b. A blockchain may be a distributed ledger that includes blocks of records that are securely linked by cryptographic hashes. Each block of records includes a cryptographic hash of the previous block, and transaction data for transactions that occurred during a time period. The blockchain may be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain may maintain data quality (e.g., through data replication) and may improve data trust (e.g., by reducing or eliminating central data control).

In some implementations, a data source may include one or more machine learning systems 890c. The machine learning system(s) 890c, for example, may be used to analyze data from various sources (e.g., data provided by the computing device 810, data from the data store(s) 890a, data from the blockchain(s) 890b, and/or data from other data sources), to identify patterns in the data, and to draw inferences from the data patterns. In general, training data 892 may be provided to one or more machine learning algorithms 894, and the machine learning algorithm(s) may generate a machine learning model 896. Execution of the machine learning algorithm(s) may be performed by the computing device 810, or another appropriate device. Various machine learning approaches may be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques may be employed, including but not limited to convolutional neural networks (CNNs), deep neural networks (DNNs), recurrent neural networks (RNNs), and other types of multi-layer neural networks. With respect to the technology described herein, the training data can include data that represents changes in gas price and corresponding changes to transaction volumes over time. The machine learning model that results from the machine learning algorithm(s) can be used to modify parameters used in calculations for determining gas price values. Use of the machine learning model can provide the benefit of improved transaction load balancing.

Various implementations of the systems and techniques described herein may be realized in digital electronic circuitry, integrated circuitry, specially designed ASICs (application specific integrated circuits), computer hardware, firmware, software, and/or combinations thereof. A computer program product may be tangibly embodied in an information carrier (e.g., in a machine-readable storage device), for execution by a programmable processor. Various computer operations (e.g., methods described in this document) may be performed by a programmable processor executing a program of instructions to perform functions of the described implementations by operating on input data and generating output. The described features may be implemented in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, by a computer to perform a certain activity or bring about a certain result. A computer program may be written in any form of programming language, including compiled or interpreted languages, and may be deployed in any form, including as a stand-alone program or as a module, component, subroutine, or other unit suitable for use in a computing environment. A computer program product may be a computer-or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and may be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer may also include, or may be operatively coupled to communicate with, one or more mass storage devices for storing data files. Such devices may include magnetic disks (e.g., internal hard disks and/or removable disks), magneto-optical disks, and optical disks. Storage devices suitable for tangibly embodying computer program instructions and data may include all forms of non-volatile memory, including by way of example semiconductor memory devices, flash memory devices, magnetic disks (e.g., internal hard disks and removable disks), magneto-optical disks, and optical disks. The processor and the memory may be supplemented by, or incorporated in, ASICs (application-specific integrated circuits).

The systems and techniques described herein may be implemented in a computing system that includes a back end component (e.g., a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). The computer system may include clients and servers, which may be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments may also be implemented in combination in a single embodiment in part or in whole. Conversely, various features that are described in the context of a single embodiment may also be implemented in multiple embodiments separately or in any suitable subcombination. Moreover, although features may be described herein as acting in certain combinations and/or initially claimed as such, one or more features from a claimed combination may in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

1. A computer-implemented method for performing asynchronous execution of blockchain transactions by a node of a blockchain network, the method comprising:
receiving a set of ordered and unexecuted transactions from a generated block of a blockchain;
adding the set of ordered and unexecuted transactions at the end of a first-in, first-out (FIFO) transaction queue;
sequentially processing one or more unexecuted transactions of the FIFO transaction queue by an execution worker of the node, the sequential processing comprising, for each unexecuted transaction:
removing the unexecuted transaction from the front of the FIFO transaction queue;
executing the unexecuted transaction, thereby generating an executed transaction; and
after executing the unexecuted transaction, (i) generating a receipt for the executed transaction, and (ii) adding the receipt for the executed transaction to current chunk data;
while executing the unexecuted transaction, determining whether a current chunk's remaining gas limit is sufficient for completing execution of a given unexecuted transaction; and
in response to determining that the current chunk's remaining gas limit is insufficient for completing execution of the given unexecuted transaction or that the transaction queue has been depleted, (i) determining a current state value that reflects a current state of the blockchain network before completing the given unexecuted transaction, (ii) adding the current state value to the current chunk data, (iii) providing the current chunk data to a consensus worker of the node for settlement in a subsequent generated block of the blockchain.

2. The computer-implemented method of claim 1, further comprising:
continuing to execute the given unexecuted transaction after providing the current chunk data to the consensus worker; and
after completing execution of the given transaction, (i) generating a given receipt for the given transaction, and (ii) adding the given receipt for the given transaction to subsequent chunk data of a subsequent chunk.

3. The computer-implemented method of claim 1, wherein the FIFO transaction queue is maintained consistently across a plurality of blockchain nodes, and each transaction is deterministically scheduled for execution in an order agreed upon during a consensus process in which the consensus worker performs.

4. The computer-implemented method of claim 1, wherein the current chunk is associated with a fixed time interval.

5. The computer-implemented method of claim 1, wherein the current chunk is associated with a predefined gas limit.

6. The computer-implemented method of claim 5, further comprising:
calculating a gas price for the unexecuted transaction using a pricing function of accumulated excess gas consumption relative to a target gas rate;
determining whether the unexecuted transaction satisfies a worst-case validity condition based on the calculated gas price, and based on the predefined gas limit for the current chunk; and
executing the unexecuted transaction, in response to determining that the given unexecuted transaction satisfies the worst-case validity condition based on the calculated gas price and a predefined gas limit.

7. The computer-implemented method of claim 1, wherein a maximum cap is imposed on the transaction queue.

8. The computer-implemented method of claim 1, wherein the execution worker and the consensus worker of the node process transactions asynchronously and in parallel.

9. A system for performing asynchronous execution of blockchain transactions, the system comprising:
a plurality blockchain nodes, with each node comprising a data processing apparatus including one or more processors, memory, and storage devices storing instructions that, when executed, cause the one or more processors to perform operations comprising:
receiving a set of ordered and unexecuted transactions from a generated block of a blockchain;
adding the set of ordered and unexecuted transactions at the end of a first-in, first-out (FIFO) transaction queue;
sequentially processing one or more unexecuted transactions of the FIFO transaction queue by an execution worker of the node, the sequential processing comprising, for each unexecuted transaction:
removing the unexecuted transaction from the front of the FIFO transaction queue;
executing the unexecuted transaction, thereby generating an executed transaction; and
after executing the unexecuted transaction, (i) generating a receipt for the executed transaction, and (ii) adding the receipt for the executed transaction to current chunk data;
while executing the unexecuted transaction, determining whether a current chunk's remaining gas limit is sufficient for completing execution of a given unexecuted transaction; and
in response to determining that the current chunk's remaining gas limit is insufficient for completing execution of the given unexecuted transaction or that the transaction queue has been depleted, (i) determining a current state value that reflects a current state of the blockchain network before completing the given unexecuted transaction, (ii) adding the current state value to the current chunk data, (iii) providing the current chunk data to a consensus worker of the node for settlement in a subsequent generated block of the blockchain.

10. The system of claim 9, the operations further comprising:
continuing to execute the given unexecuted transaction after providing the current chunk data to the consensus worker; and
after completing execution of the given transaction, (i) generating a given receipt for the given transaction, and (ii) adding the given receipt for the given transaction to subsequent chunk data of a subsequent chunk.

11. The system of claim 9, wherein the FIFO transaction queue is maintained consistently across the plurality of blockchain nodes, and each transaction is deterministically scheduled for execution in an order agreed upon during a consensus process in which the consensus worker performs.

12. The system of claim 9, wherein the current chunk is associated with a fixed time interval.

13. The system of claim 9, wherein the current chunk is associated with a predefined gas limit.

14. The system of claim 13, the operations further comprising:
calculating a gas price for the unexecuted transaction using a pricing function of accumulated excess gas consumption relative to a target gas rate;
determining whether the unexecuted transaction satisfies a worst-case validity condition based on the calculated gas price, and based on the predefined gas limit for the current chunk; and
executing the unexecuted transaction, in response to determining that the given unexecuted transaction satisfies the worst-case validity condition based on the calculated gas price and a predefined gas limit.

15. The system of claim 9, wherein a maximum cap is imposed on the transaction queue.

16. The system of claim 9, wherein the execution worker and the consensus worker of the node process transactions asynchronously and in parallel.

17. A non-transitory computer-readable storage medium coupled to one or more processors and having instructions stored thereon which, when executed by the one or more processors, cause the one or more processors to perform operations for performing asynchronous execution of blockchain transactions by a node of a blockchain network, the operations comprising:
receiving a set of ordered and unexecuted transactions from a generated block of a blockchain;
adding the set of ordered and unexecuted transactions at the end of a first-in, first-out (FIFO) transaction queue;
sequentially processing one or more unexecuted transactions of the FIFO transaction queue by an execution worker of the node, the sequential processing comprising, for each unexecuted transaction:
removing the unexecuted transaction from the front of the FIFO transaction queue;
executing the unexecuted transaction, thereby generating an executed transaction; and
after executing the unexecuted transaction, (i) generating a receipt for the executed transaction, and (ii) adding the receipt for the executed transaction to current chunk data;
while executing the unexecuted transaction, determining whether a current chunk's remaining gas limit is sufficient for completing execution of a given unexecuted transaction; and
in response to determining that the current chunk's remaining gas limit is insufficient for completing execution of the given unexecuted transaction or that the transaction queue has been depleted, (i) determining a current state value that reflects a current state of the blockchain network before completing the given unexecuted transaction, (ii) adding the current state value to the current chunk data, (iii) providing the current chunk data to a consensus worker of the node for settlement in a subsequent generated block of the blockchain.

18. The non-transitory computer-readable storage medium of claim 17, the operations further comprising:
continuing to execute the given unexecuted transaction after providing the current chunk data to the consensus worker; and
after completing execution of the given transaction, (i) generating a given receipt for the given transaction, and (ii) adding the given receipt for the given transaction to subsequent chunk data of a subsequent chunk.

19. The non-transitory computer-readable storage medium of claim 17, the operations further comprising:
calculating a gas price for the unexecuted transaction using a pricing function of accumulated excess gas consumption relative to a target gas rate;
determining whether the unexecuted transaction satisfies a worst-case validity condition based on the calculated gas price, and based on a predefined gas limit for the current chunk; and
executing the unexecuted transaction, in response to determining that the given unexecuted transaction satisfies the worst-case validity condition based on the calculated gas price and a predefined gas limit.

20. The non-transitory computer-readable storage medium of claim 17, wherein the execution worker and the consensus worker of the node process transactions asynchronously and in parallel.
